(19) United States
(12) Patent Application Publication
(10) Pub. No.: US 2018/0133735 A1
(43) Pub. Date: May 17, 2018

(54) SPRAY COATING OF CANS

(71) Applicant: CROWN PACKAGING TECHNOLOGY, INC., Alsip, IL (US)

(72) Inventor: Andrew John WILKINSON, Yorkshire (GB)

(21) Appl. No.: 15/577,861

(22) PCT Filed: May 16, 2016
(86) PCT No.: PCT/GB2016/051401

§ 371 Date: Nov. 29, 2017

(30) Foreign Application Priority Data
May 29, 2015 (GB) 1509260.4

(51) Int. Cl. B05B 12/02; B05B 13/02; B05B 13/06

(52) U.S. Cl. CPC B05B 12/02; B05B 13/0242; B05B 13/069; B05B 13/0645; B05B 13/0609

(57) ABSTRACT

A can body spraying machine comprises a can body spinning device, a spray gun for spraying a coating onto an interior of a can body mounted on the can body spinning device and a controller configured to cause the spray gun to switch when the can body spinning device is in a correct spraying position. A sensor coupled to the can body spinning device determines when the can body spinning device has undergone a predefined rotation following commencement of spraying and, in response to such determination, causes the spray gun to be switched off.

### TECHNICAL FIELD

The present invention relates to the spray coating of cans. More particularly, though not necessarily, the invention relates to the spray coating of can body interiors.

### BACKGROUND

It is well known for can bodies to receive an internal protective coating, generally termed a “lacquer”. This coating is in direct contact with the can contents once the can is packed and minimises any interaction between the contents and the can interior. The coating must be able to withstand both the can manufacturing process and the can's subsequent use, for the duration of its shelf life. For beverage and food cans, the coating must be non-toxic and non-tainting. A minimum weight/thickness of coating must normally be applied in order to comply with specific legislation.

Typically, a spray coating machine forms part of a can production line and may process 300-400 cans per minute. Cans are typically either two-piece or three-piece cans. The former comprise a can body punched from a single disc of metal, with integral sidewalls and base. Following filling, a lid is seamed onto the open end. A three-piece can comprises a can body formed by rolling a sheet of metal into a cylinder and welding the seam. A bottom end is seamed onto the can prior to filling, with a top end being seamed to the can body following filling. A three piece can may be sprayed either before or after the bottom end is attached to the can body. In the following discussion, reference to a “can body” refers to either a two-piece can without the top end attached, or to a three piece can body without the top end attached, with or without the bottom end attached.

Unsprayed can bodies are fed into the spray machine where they are held by vacuum suction on a number of spinner pads, also known as vacuum chucks, arranged around a central rotary indexing turret. Where the can bodies being sprayed are steel, they may be held in place on the spinner pads magnetically. An indexing box, comprising an internal cam, moves (indexes) the rotary indexing turret and associated spinner pads and attached can bodies into position for spraying at the appropriate time. Once in position, the spinner pad is supplied with rotational drive, typically via a motorised drive belt, which in turn spins the attached can body at 2000-2750 rpm (revolutions per minute) while it is internally spray coated with lacquer by one or more spray guns. Spinning during spraying is required to ensure a uniform coating over the entire internal surface of the can body. For a can body rotating at 2400 rpm, three full can body revolutions is considered appropriate in order to ensure that the correct amount of lacquer is evenly applied. This means that spraying time per can body is around 100 ms (milliseconds), during which time the indexing box maintains the rotary indexing turret stationary (known as the “dwell time”). Once spraying is complete, the indexer moves the sprayed can body out of position and moves the next unsprayed can body into position in front of the spray gun(s). Sprayed can bodies are then fed into the next stage of the production line.

Spray coating machines may use one, two or more spray guns operating in parallel. For example, a machine utilising two spray guns may spray two successive cans on the indexing turret at the same time. Each indexing of the turret causes the turret to rotate so as to bring the next two cans into line with the spray guns.

In a spraying machine such as the CarnaudMetalbox™ “3200” spray machine discussed in WO2014/147163, the spray window is monitored by two timing flags and sensors, mounted on the indexing box input shaft. The sensors are linked to the lacquer spray system and control when the spray guns switch on and switch off in relation to the rotating can body. The spray window is controlled by the motion profile of the index box. At a production speed of 350 can bodies per minute, the dwell time is 100 ms. This can be broken down into 8 ms for the spray gun to switch on, 84 ms to spray the can and 8 ms for the gun to switch off. To ensure the correct weight of lacquer is applied, a large tolerance is built into this timed spray window. This can result in an excess amount of lacquer being sprayed.

### SUMMARY OF THE INVENTION

According to a first aspect of the present invention there is provided a can body spraying machine comprising a can body spinning device, a spray gun for spraying a coating onto an interior of a can body mounted on the can body spinning device and a controller configured to cause the spray gun to switch on when the can body spinning device is in a correct spraying position. A sensor coupled to the can body spinning device determines when the can body spinning device has undergone a predefined rotation following commencement of spraying and, in response to such determination, causes the spray gun to be switched off.

As an option, the sensor may be mechanically, optically or electromagnetically coupled to the can body spinning device.

Where the sensor is optically coupled to the can body spinning device it may comprise a light source and a detector, and rotation of the can body spinning device may cause a modulation of light directed to the light source.

The light source and detector may be substantially co-located, and the detector may detect light reflected from the can body spinning device.

The light source may comprise a laser.

The can body spinning device may define a plurality of indexing holes configured to modulate light directed back to the light source.

The sensor may comprise a proximity sensor, for example, an electromagnetic sensor.

The can body spinning device may comprise a vacuum chuck or a magnetic chuck for mounting a can body.

The can body spraying machine may comprise a plurality of can body spinning devices attached to a rotating indexing turret, and may be configured to index the can body spinning devices in sequence into line with the spray gun.

The controller may comprise a mechanical timing mechanism.

According to a second aspect of the present invention there is provided a method for spraying a coating onto an interior of a can body and comprising: mounting a can body on a can body spinning device; bringing the can body spinning device and mounted can body into line with a spray gun; commencing spraying using the spray gun; using a sensor coupled to the can body spinning device to determine when the can body spinning device has undergone a predefined rotation following commencement of spraying; and in response to such determination, switching off the spray gun.

The sensor may be mechanically, optically or electromagnetically coupled to the can body spinning device.

Where the sensor is optically coupled to the can body spinning device, the method may comprise directing a light from the sensor onto the can body spinning device and detecting a modulation of the light caused by the can body spinning device.

Where the sensor is electromagnetically coupled to the can body spinning device, the method may comprise using the sensor to detect modulation of an electromagnetic field caused by rotation of the can body spinning device.

Modulation may be caused by a plurality of indexing holes, apertures or other features provided on or around the can body spinning device.

### BRIEF DESCRIPTION OF THE DRAWINGS

FIG. 1 is a diagrammatic representation of a conventional can body spraying machine;

FIG. 2 is a perspective view of part of a can body spraying assembly;

FIG. 3 is a perspective view of a chuck pulley for use in the assembly of FIG. 2;

FIG. 4 is a sectional view of the assembly of FIG. 2;

FIG. 5a is a diagrammatic representation of the number of can body wraps in a known spraying assembly;

FIG. 5b is a diagrammatic representation of the number of can body wraps in the assembly of FIG. 2; and

FIG. 6 is a flow diagram illustrating a method of operating a spraying machine.

### DETAILED DESCRIPTION

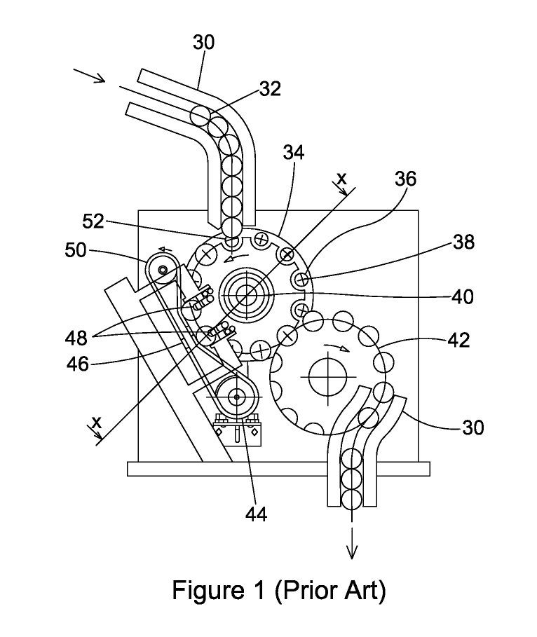

FIG. 1 is a diagrammatic view of a known can body spraying machine. In this arrangement, unsprayed can bodies 32 enter the sprayer via a trackway 30, where they are received in pockets 52 comprising a vacuum chuck 36 and a chuck pulley 38. Multiple pockets 52 are disposed around a circular rotary indexing turret 34. The turret 34 is indexed around the turret centre 40 by an indexing box (not shown here), such that two successive can bodies 32 are indexed in turn into position for spraying.

As each pair of can bodies 32 is moved into position in front of respective spray guns 48, the chuck pulley 38 on which the vacuum chucks 36 and can bodies 32 are mounted engages with a motorised drive belt, comprising a drive motor 44, drive belt 46 and idler pulley 50. This engagement causes the chuck pulleys 48, vacuum chucks 36 and hence can bodies 32 to spin.

Mounted on the indexing box input shaft (not shown here) are two timing “flags”, each of which acts as a physical timing flag. The flags have different angular shapes to define the spraying window. Proxy (proximity) sensors are used to ascertain the positions of the flags and to signal the lacquer control system to turn the spray guns on and off. The spray window is based solely on timing, as controlled by the motion profile of the indexing box. Once spraying is complete, the pair of sprayed can bodies 32 is indexed on, and leaves the spraying machine by way of discharge turret 42 and trackway 30.

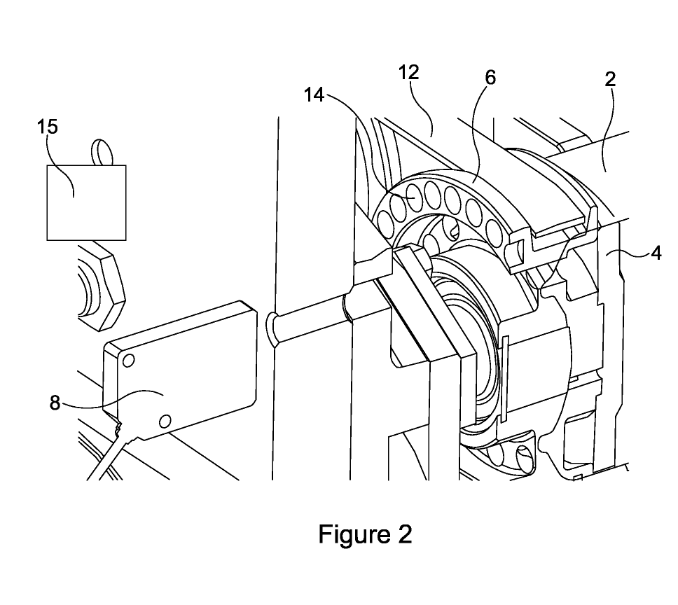

FIG. 2 is a perspective cross-sectional view of a part of an improved apparatus 10 for use in a can body spraying machine. The assembly comprises a vacuum chuck 4 on which is mounted a can body 2. The vacuum chuck 4 is in engagement with a chuck pulley 6, which in turn is driven by a motorised drive belt 12. In this example, the chuck pulley 6 is further provided with multiple cylindrical indexing holes 14, the chuck pulley 6 being within line of sight of a laser sensor 8. As the chuck pulley 6 engages with the motorised drive belt 12, the vacuum chuck 4 spins about a central axis. As the chuck 4 spins, so does the mounted can body 2. This allows an interior of the can body 2 to receive an even coating of lacquer from one or more spray guns, as will be described below. The apparatus 10 also comprises a controller 15, positioned such that it switches the spray gun on when the chuck pulley 6 is in the correct position for spraying.

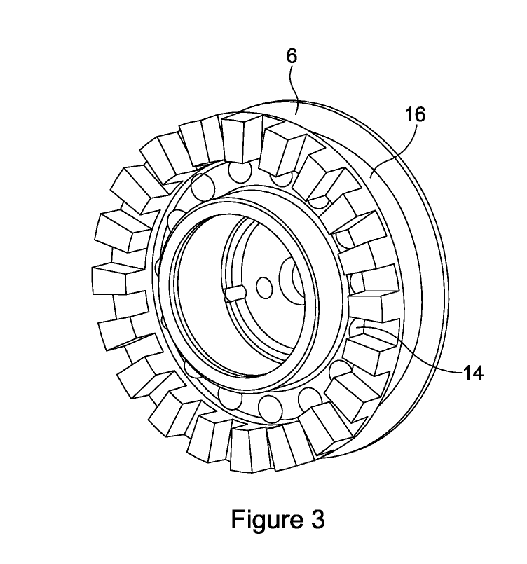

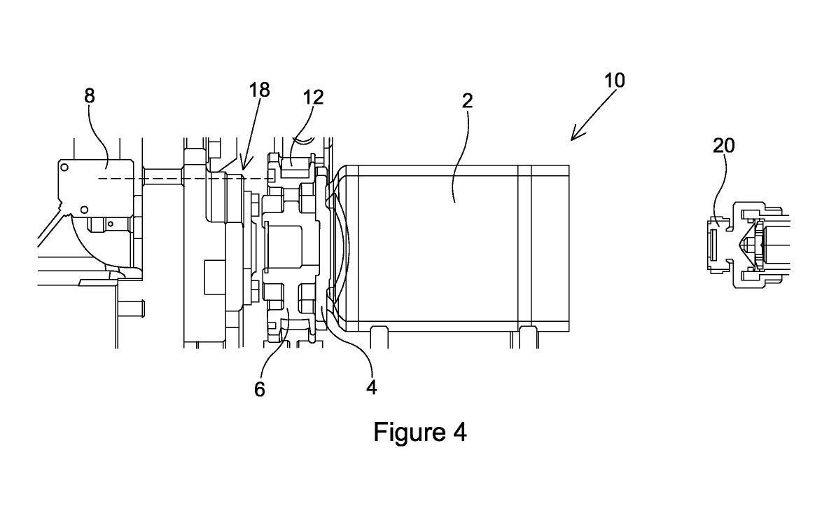

FIG. 3 is a perspective view of the chuck pulley 6, for use in the assembly of FIG. 2. The pulley 6 is substantially cylindrical and is provided with a drive belt groove 16 around an outer circumference. The belt groove 16 enables the pulley 6 to be driven by the motorised drive belt 12 (not shown in FIG. 3), causing the pulley 6 to rotate about a central axis. As can be seen in the Figure, the pulley 6 has fifteen indexing holes 14, equally distributed around the pulley 6. FIG. 4 is a further sectional view of the apparatus 10 for use in a can body spraying machine, illustrating the can body 2 in its entirety and the spray gun 20. Typically, the can body 2 spins at around 2000 to 2750 rpm.

As will be clear from FIG. 4, the laser sensor 8 is mounted on the opposite side of the pulley 6 from the vacuum chuck 4, and faces the indexing holes 14 (not shown in FIG. 4) in the pulley 6. The sensor 8 is in signal communication with the spray gun 20 and can signal the spray gun 20 to switch off. As the vacuum chuck 4 is indexed into position in front of the spray gun 20, the chuck pulley 6 engages with the motorised drive belt 12 and the pulley 6, vacuum chuck 4 and can body 2 begin to spin. At this time, the spray gun 20 switches on and begins spraying the interior of the spinning can body 2 with lacquer. Spinning the can body 2 as it is sprayed ensures an even coating of lacquer from the spray gun 20.

The sensor 8 monitors the total number of revolutions of the chuck pulley 6, with counting commencing when the spray gun is switched on, or possibly after some predefined time period following switching on of the spray gun (sufficient to reach a desired discharge rate for the gun), by counting the number of indexing holes passing through its line of sight 18. It will be appreciated that as the indexing holes pass across the laser beam generated by the sensor 8, the light reflected back to the sensor will be modulated (the assumes of course that the inner surfaces of the indexing holes are sufficiently reflective, e.g. by applying a silvering to the holes). By employing an appropriate detector at the sensor, this modulation can be detected and decoded to generate the required count.

Once the sensor has counted the requisite number of indexing holes, it signals to the spray gun 20 causing the spray gun 20 to switch off and stop spraying. In this illustrated example, since there are fifteen indexing holes 14 in total, one full revolution of the chuck pulley 6 will have occurred once fifteen indexing holes have passed the line of sight 18 of the sensor 8. If three revolutions of the can body are required to ensure an appropriate coating, the sensor will signal to the spay gun to switch off when the count reaches forty-five (or forty-six to ensure an overlap).

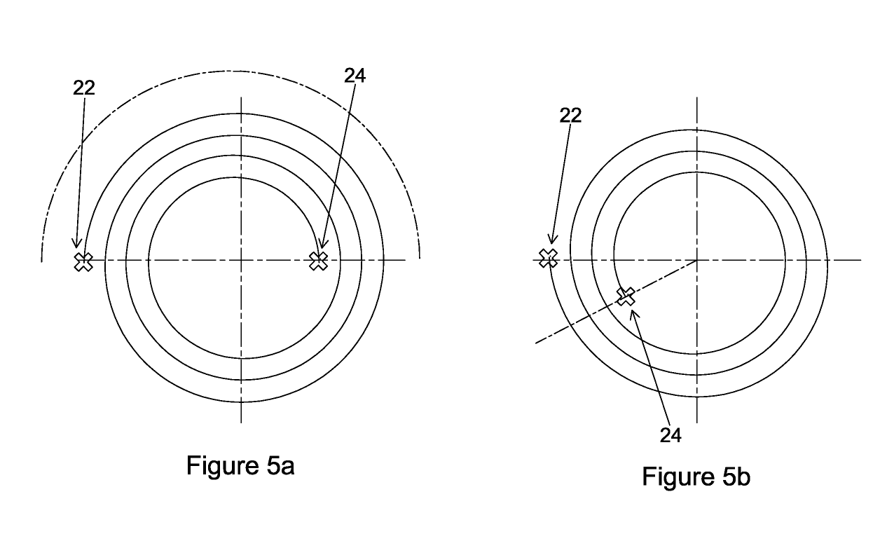

FIGS. 5a and 5b are diagrammatic representations of the number of can wraps (complete can body rotations) in a conventional can body spraying assembly and in the assembly of FIGS. 2 to 4, respectively. In these representations, spraying of the can body 2 begins at points 22 and ends at points 24. In a conventional assembly represented in FIG. 5a, the spray window, i.e. the spraying time, during which the can body 2 is sprayed by the spray gun 20, is controlled by timers. In other words, the spray gun 20 switches on 22 and off 24 at predetermined times irrespective of the actual position of the can body 2. The spray window is typically fixed at 100 ms. This window includes a certain tolerance to ensure that the can body 2 has arrived in the correct spraying position and that the amount of lacquer applied is at least the minimum amount required. This tolerance in the spray window may require 3.5 can wraps (3.5 complete can body revolutions) rather than the 3 can body wraps actually required to ensure the correct weight of lacquer is applied to the can body 2 interior. This tolerance results in lacquer wastage of around 0.5 “coats” of lacquer per can body. Fresh water, which is employed in the spraying process, is also wasted.

In the improved assembly described here, with the spray profile represented in FIG. 5b, the duration of the spray window is not timer controlled. Rather, the spray window is controlled by the sensor 8 which has direct line of sight 18 of the indexing holes 14 on the pulley 6. The spray window begins at a given time in the operating sequence of the machine, controlled by a mechanical timing mechanism, such as a timing flag, whereupon the spray gun 20 commences spraying an interior of a spinning can body 2 with a coating of lacquer. Once the sensor 8 determines that the chuck pulley 6 and therefore the can body 2 has undergone the required predefined number of full revolutions following commencement of spraying as described above, the sensor 8 communicates with the spray gun 20 and causes the spray gun 20 to switch off. The sensor 8 monitors the angular position of the can body 2 by tracking the number of times the chuck pulley 6 has completed a full revolution. This corresponds to the total spraying time required to ensure the appropriate weight of lacquer is applied to the can body 2 interior.

The arrangement of FIG. 5b as described above results in a shorter spray window, since the tolerance built into the timer controlled spray window is no longer required. This increases the overall can body per minute output of the lacquer spraying machine, as the timing of the indexing box can be configured to accommodate the reduced spray window, in order to index the sprayed can body on more quickly. The total number of can body wraps in this example is reduced from approximately 3.5 to 3.05, as indicated in FIG. 5b. Three full coats of lacquer are guaranteed, but the overlap is reduced to around 0.05 wraps (18 degrees). This leads to a lacquer saving of around 0.45 wraps (162 degrees) per can body. Additionally, the rotational speed of the can body during the lacquer spraying process can be monitored.

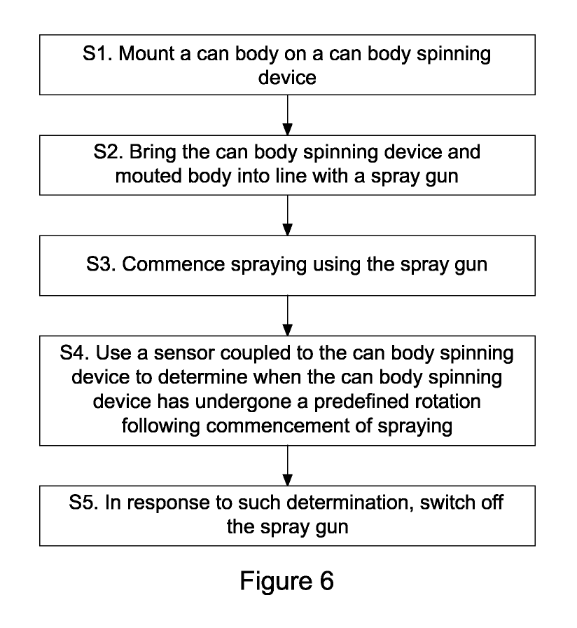

FIG. 6 is a flow diagram illustrating a method of operating a spraying machine to spray a coating onto an interior of a can body. The method comprises the following steps:

S1: Mount a can body on a can body spinning device

S2: Bring the can body spinning device and mounted can body into line with a spray gun

S3: Commence spraying using the spray gun

S4: Use a sensor coupled to the can body spinning device to determine when the can body spinning device has undergone a predefined rotation following commencement of spraying

S5: In response to such determination, switch off the spray gun.

It will be appreciated by the person skilled in the art that various modifications may be made to the above described embodiments, without departing from the scope of the present invention.

For example, rather than a chuck pulley and motorised drive belt arrangement, drive may be supplied to the vacuum or magnetic chuck and can by a gear mechanism, or by other means.

The total number, size, shape and distribution of the chuck pulley indexing holes may be varied. For example, rather than the 15 circular holes shown in FIG. 3, there may be a greater number of indexing holes, such as 20 to 60, optionally 40, or a smaller number, such as 10. In some embodiments, a single indexing hole or other feature may be sufficient. Other features may include slots or apertures.

Alternative methods of monitoring the total number of revolutions of the chuck pulley may be employed. The sensor may be mechanically, optically or electromagnetically coupled to the can body spinning device. For example, a plurality of mirrored surfaces may replace the indexing holes described above. Alternatively, the chuck pulley may be provided with one or more magnets which would allow a magnetic-based sensor to monitor its angular position.

The optically coupled sensor as described above may comprise a laser sensor, configured to reflect a laser beam from a surface of the chuck pulley, detecting a change in depth as each indexing holes passes through the sensor's line of sight. The associated light source and detector may be co-located. Alternatively, the detector may be located on an opposite side of the pulley from the light source.

Alternative forms of sensor, which may be configured to operate with alternatives to the indexing holes described above, may be employed. A proxy or proximity sensor may be used, such as an electromagnetic sensor. The sensor may detect modulation of an electromagnetic field, caused by rotation of the can body spinning device. The sensor may be mechanically, optically or electromagnetically coupled to the chuck pulley.

The controller may comprise a mechanical timing mechanism, such as a timing flag.

More than one spray gun may be supplied in the assembly, or the can body may be sprayed at more than one location. For example, the can body may be sprayed at up to four multiple locations.

More than one sensor may be employed in the detection of the can body position. Additional sensors may be located in any position within the assembly suitable for monitoring the chuck pulley.

Communication between the sensor(s) and the spray gun(s) may be by any suitable means, for example, wired or wireless or by a combination of means.

It will be appreciated that the weight or thickness of lacquer required in any particular application will depend upon the size and shape of the can body being sprayed. Three can body wraps of lacquer is an example of one application, as described herein.

The assembly described above may be utilised in the spray coating of a range of can bodies, for example two-piece food and beverage can bodies. The assembly may be used with both steel and aluminium can bodies.

1. A can body spraying machine comprising:
a can body spinning device;
a spray gun configured for spraying a coating onto an interior surface of a can body mounted on the can body spinning device;
a controller configured to cause the spray gun to switch on and thereby commence spraying when the can body spinning device is in a correct spraying position; and
a sensor coupled to the can body spinning device and configured to determine when the can body spinning device has undergone a predefined rotation following commencement of spraying; whereby the controller is configured such that, in response to said determination, the spray gun ceases spraying.

2. A machine as claimed in claim 1, wherein the sensor is mechanically, optically or electromagnetically coupled to the can body spinning device.

3. A machine as claimed in claim 2, wherein the sensor is optically coupled to the can body spinning device and comprises a light source and a detector, rotation of the can body spinning device causing a modulation of light directed to the light source.

4. A machine as claimed in claim 3, wherein said light source and detector are substantially co-located, and the detector detects light reflected from the can body spinning device.

5. A machine as claimed in claim 3, wherein said light source comprises a laser.

6. A machine as claimed in claim 3, wherein the can body spinning device defines a plurality of indexing holes configured to modulate light directed back to the light source.

7. A machine as claimed in claim 1, wherein the sensor is a proximity sensor.

8. A machine as claimed in claim 1, wherein the can body spinning device comprises a vacuum chuck or a magnetic chuck for mounting a can body.

9. A machine as claimed in claim 1 and further comprising a plurality of said can body spinning devices attached to a rotating indexing turret, and wherein the machine configured to index the can body spinning devices in sequence into line with the spray gun.

10. A machine as claimed in claim 1, wherein said controller comprises a mechanical timing mechanism.

11. A method of spraying a coating onto an interior of a can body and comprising:
mounting a can body on a can body spinning device;
bringing the can body spinning device and mounted can body into line with a spray gun;
commencing spraying using the spray gun;
using a sensor coupled to the can body spinning device to determine when the can body spinning device has undergone a predefined rotation following commencement of spraying; and
in response to said determination in said using step, switching off the spray gun.

12. The method of claim 11, wherein the sensor is mechanically, optically or electromagnetically coupled to the can body spinning device.

13. The method of claim 12, wherein the sensor is optically coupled to the can body spinning device, the method comprising directing a light from the sensor onto the can body spinning device and detecting a modulation of the light caused by the can body spinning device.

14. The method of claim 12, wherein the sensor is electromagnetically coupled to the can body spinning device, the method comprising using the sensor to detect modulation of an electromagnetic field caused by rotation of the can body spinning device.

15. The method of claim 13, wherein said modulation is caused by a plurality of indexing holes, apertures or other features provided on or around the can body spinning device.

16. A machine as claimed in claim 7, wherein the proximity sensor is an electromagnetic sensor.
